(19) United States
(12) Patent Application Publication
(10) Pub. No.: US 2017/0036333 A1
(43) Pub. Date: Feb. 9, 2017

(54) Magazine Assembly for Accommodating of Nail Clips

(71) Applicant: NAILERMATE ENTERPRISE CORPORATION, Taichung City (TW)

(72) Inventor: Wen-Pin LIN, Taichung City (TW)

(73) Assignee: Nailermate Enterprise Corporation

(21) Appl. No.: 14/818,157

(22) Filed: Aug. 4, 2015

(51) Int. Cl. B25C 1/00

(52) U.S. Cl. CPC B25C 1/001

(57) ABSTRACT

A magazine assembly for accommodating of nail clips is used in combination with a nail gun, and includes: a magazine, a nail pushing assembly, and a muzzle. With the inserting portions of the nail clips and the nails received in the nail holding groove, the clipping portions of the nail clips received in the sliding groove, and the restricting protrusion received in the retaining space of the nail clips, the nail clips can be held firmly in the magazine. Besides, the punching groove and the nail feeding hole of the muzzle are in communication with the magazine to allow the nail clips to be pushed into the punching groove where the nail clips can be fired. Hence, the magazine assembly is not only capable of accommodating but also firing the nail clips.

### BACKGROUND OF THE INVENTION

Field of the Invention

The present invention relates to a magazine assembly, and more particularly to a magazine assembly for accommodating of nail clips.

Description of the Prior Art

Nail guns have found wide application in industrial field, and are generally categorized into electric type and pneumatic type. Each of the nail guns essentially includes a gun body and a magazine. The magazine is provided for accommodating nails, and at one end of the magazine is formed a muzzle. The nail gun includes a hammer which extends into the muzzle to hit the nail located therein.

Firing of the nails will be failed under the following two circumstances: when the nails are jammed or when the magazine is empty. However, the conventional magazine is usually a closed structure, and therefore the inside of the magazine is invisible unless the magazine is dismantled, which is troublesome and time consuming

Apart from the nails, there is a nail clip which is used to fix the wire, cable or pipe to a surface. However, the user has to use a hammer to hammer the nail clip into the surface of an object, which is laborsome and time consuming.

### SUMMARY OF THE INVENTION

The present invention is aimed at providing a magazine assembly which is not only capable of accommodating but also can the nail clips.

The present invention is further aimed at providing a magazine assembly which facilitates the monitoring of the inside of the magazine.

A magazine assembly for accommodating of nail clips of a preferred embodiment of the present invention is used in combination with a nail gun, each of the nail clips includes a clip base and a nail, the clip base includes a clipping portion and an inserting portion for insertion of the nail a direction in which the nail is inserted being defined as an inserting direction, and between the clipping portion and the inserting portion is defined a retaining space. The magazine assembly includes:

a magazine with an input end and an output end, a direction running from the input end to the output end is defined as a radial direction, the magazine includes a nail holding groove and a sliding groove which are in communication with each other and extend in the radial direction, the nail holding groove is provided for accommodating of the inserting portions of the nail clips and the nails, and the sliding groove is provided for accommodating the clipping portions of the nail clips, between the nail holding groove and the sliding groove is formed a restricting protrusion which is formed to fit in the retaining space of the nail clips, each of the clipping portions of the nail clips sits over a corresponding one of the restricting protrusions;

a nail pushing assembly includes a pushing member, a pushing piece and a coil spring, the pushing member is disposed in the sliding groove and slidable along the radial direction, and includes a spring slot, a pressing slot and a pushing slot in communication with the pressing slot, wherein the spring slot and the pushing slot are in communication with the nail holding groove and the output end, the pushing piece is pivoted to the pushing member and includes a pressing end and a pushing end, the pivot point of the pushing piece is located between the pressing end and the pushing end, the pressing end is located in the pressing slot, the pushing end is located in the pushing slot and inserted in the sliding groove to press against the nail clips, the coil spring is revolvably disposed in the spring slot, wherein the coil spring has a positioning end fixed to the output end of the magazine, and has another end disposed in the spring slot, an elastic member disposed between the mounting seat and the pressing end of the pushing piece; and

a muzzle which is disposed at the output end of the magazine and includes a punching groove and a nail feeding hole which are in communication with each other, wherein the nail feeding hole extends along the radial direction and is in communication with the nail holding groove and the sliding groove of the magazine, the punching groove extends in the inserting direction, one end of the punching groove is formed with a hammer hole, and another end of the punching groove is formed with a firing hole.

With the inserting portions of the nail clips and the nails received in the nail holding groove, the clipping portions of the nail clips received in the sliding groove, and the restricting protrusion received in the retaining space of the nail clips, the nail clips can be held firmly in the magazine. Besides, the punching groove and the nail feeding hole of the muzzle are in communication with the magazine to allow the nail clips to be pushed into the punching groove where the nail clips can be fired. Hence, the magazine assembly is not only capable of accommodating but also firing the nail clips.

### BRIEF DESCRIPTION OF THE DRAWINGS

FIG. 1 shows that a magazine assembly for accommodating of nail clips in accordance with the preferred embodiment of the present invention is used in combination with a nail gun;

FIG. 2 is a perspective view of the magazine assembly for accommodating of nail clips in accordance with the preferred embodiment of the present invention;

FIG. 3 is an exploded view of the magazine assembly for accommodating of nail clips in accordance with the preferred embodiment of the present invention;

FIG. 4 is another exploded view of the magazine assembly for accommodating of nail clips in accordance with the preferred embodiment of the present invention;

FIG. 5 is a perspective view of a nail clip to be held in the magazine assembly in accordance with the preferred embodiment of the present invention;

FIG. 6 is a cross sectional view of a part of the magazine assembly for accommodating of nail clips in accordance with the preferred embodiment of the present invention;

FIG. 7 is a cross sectional view of the magazine assembly for accommodating of nail clips in accordance with the preferred embodiment of the present invention;

FIG. 8 is an operational cross sectional view of the magazine assembly for accommodating of nail clips in accordance with the preferred embodiment of the present invention;

FIG. 9 is another operational cross sectional view of the magazine assembly for accommodating of nail clips in accordance with the preferred embodiment of the present invention; and

FIG. 10 is yet an operational cross sectional view of the magazine assembly for accommodating of nail clips in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

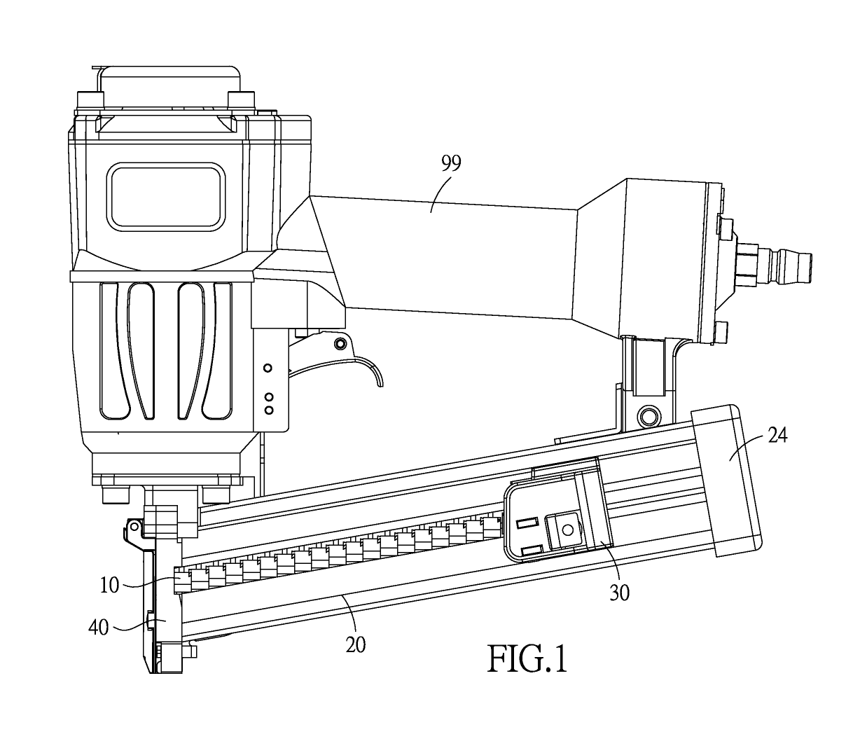

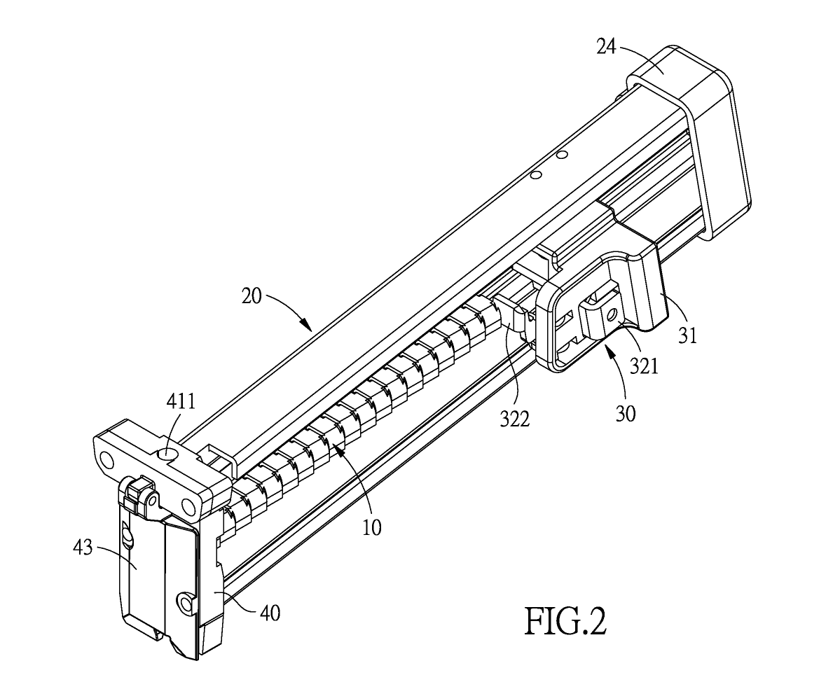

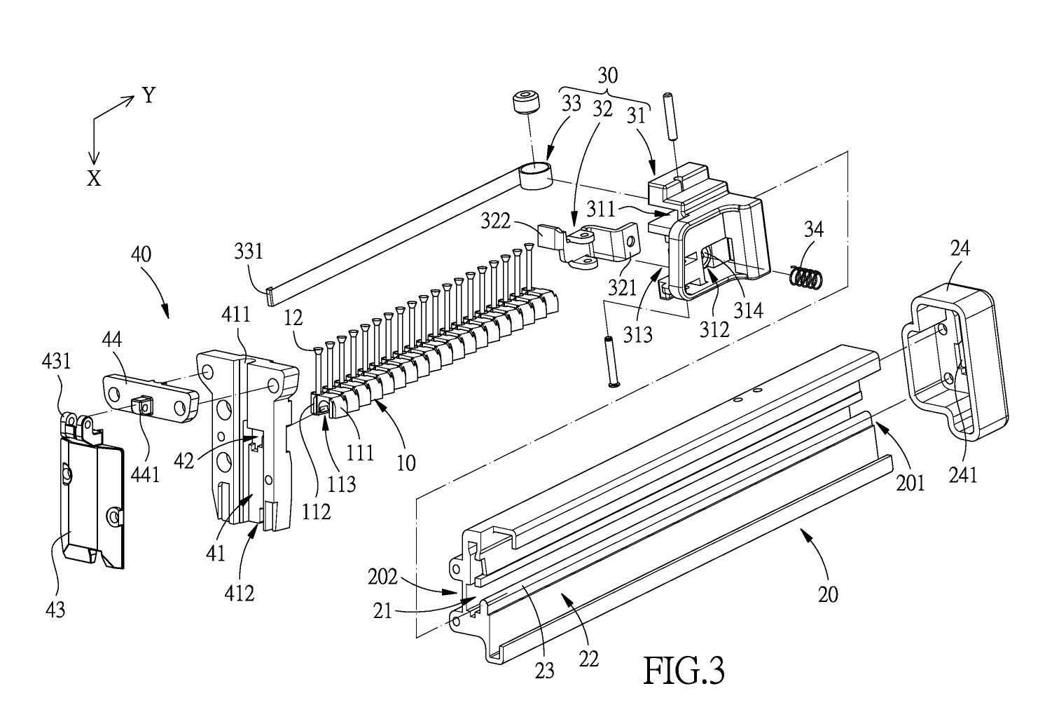

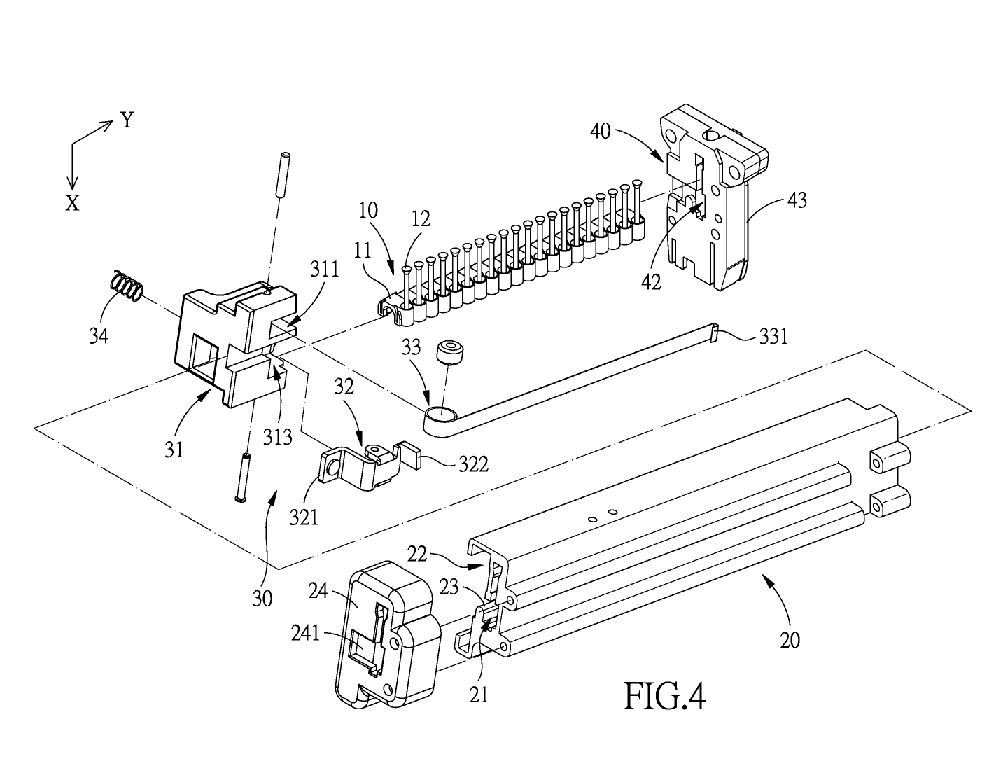

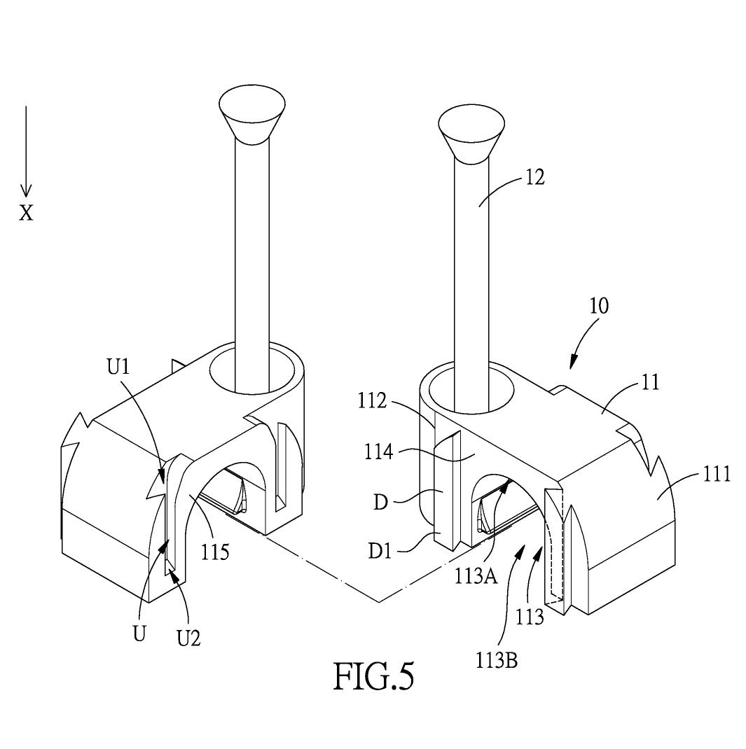

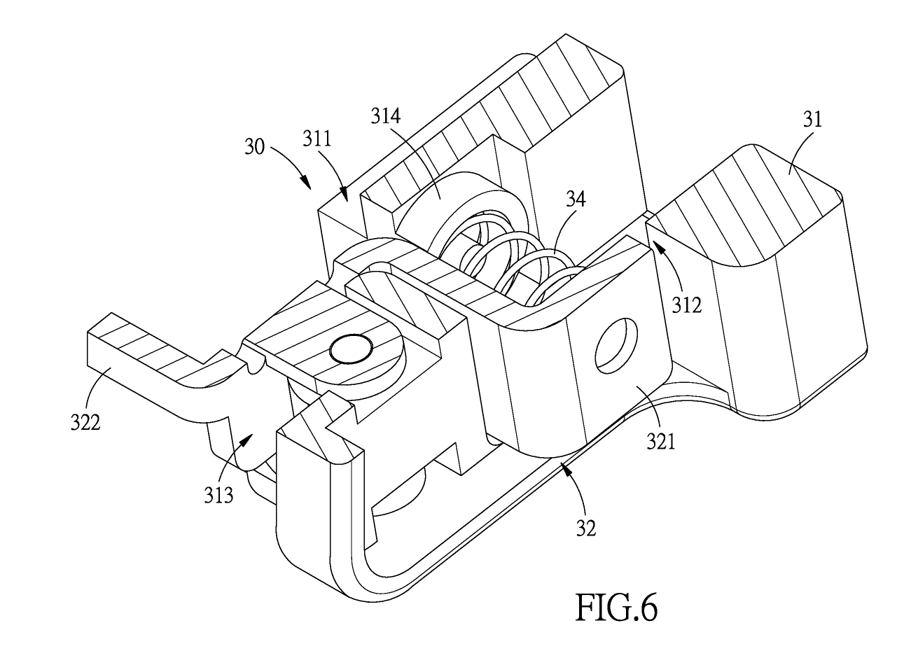

Referring to FIGS. 1-10, a magazine assembly for accommodating of nail clips 10 in accordance with a preferred embodiment of the present invention is used in combination with a nail gun 99. As shown in FIG. 5, each of the nail clips 10 includes a clip base 11 and a nail 12. The clip base 11 includes a clipping portion 111 and an inserting portion 112 for insertion of the nail 12. A direction in which the nail 12 is inserted is defined as an inserting direction X. Between the clipping portion 111 and the inserting portion 112 is defined a retaining space 113 which has a close end 113A and an open end 113B located in the inserting direction X. The clip base 11 includes a first lateral surface 114 and a second lateral surface 115. The first lateral surface 114 is provided with at least one rib D extending in the inserting direction X, and the second lateral surface 115 is provided with at least one engaging groove U located corresponding to the rib D. The rib D has a stop end D1 located adjacent to the open end 113B of the retaining space 113. The engaging groove U has an open end U1 located at the close end 113A of the retaining space 113, and a close end U2 located between the close and open ends 113A, 113B of the retaining space 113. By such arrangements, a plurality of nail clips 10 can be fastened together in a stepped manner that one nail clip 10 has the rib D engaged in the engaging groove U of another nail clip 10, and the stop end D1 of the one nail clip 10 is stopped against the close end U2 of the engaging groove U of the another nail clip 10.

The magazine assembly for accommodating of nail clips comprises a magazine 20, a nail pushing assembly 30, and a muzzle 40.

The magazine 20 is an elongated structure with an input end 201 and an output end 202. A direction running from the input end 201 to the output end 202 is defined as a radial direction Y. The magazine 20 includes a nail holding groove 21 and a sliding groove 22 which are in communication with each other and extend in the radial direction Y. The nail holding groove 21 is provided for accommodating of the inserting portions 112 of the nail clips 10 and the nails 12, and the sliding groove 22 is provided for accommodating the clipping portions 111 of the nail clips 10. Between the nail holding groove 21 and the sliding groove 22 is a restricting protrusion 23 which is formed to fit in the retaining space 113 of the nail clips 10. Each of the clipping portions 111 of the nail clips 10 sits over the restricting protrusion 23.

The nail pushing assembly 30 includes a pushing member 31, a pushing piece 32 and a coil spring 33. The pushing member 31 is disposed in the sliding groove 22 and slidable along the radial direction Y, and includes a spring slot 311, a pressing slot 312 and a pushing slot 313 in communication with the pressing slot 312. The spring slot 311 and the pushing slot 313 are in communication with the nail holding groove 21 and the output end 202. The pushing piece 32 is pivoted to the pushing member 31 and includes a pressing end 321 and a pushing end 322. The pivot point of the pushing piece 32 is located between the pressing end 321 and the pushing end 322. The pressing end 321 is located in the pressing slot 312, and the pushing end 322 is located in the pushing slot 313 and inserted in the sliding groove 22 to press against the nail clips 10. The coil spring 33 is revolvably disposed in the spring slot 311 and normally maintained in a compressed condition. The coil spring 33 has a positioning end 331 fixed to the output end 202 of the magazine 20, and has another end disposed in the spring slot 311. The spring force of the coil spring 33 provides a pushing force pushing the nail pushing assembly 30 towards the output end 202.

Preferably, the pushing member 31 is provided with a mounting seat 314 located toward the pressing slot 312, and an elastic member 34 disposed between the mounting seat 314 and the pressing end 321 of the pushing piece 32. With the spring force of the elastic member 34 exerted on the pressing end 321, the pushing end 322 of the pushing piece 32 can be pushed against the nail clips 10.

The muzzle 40 is disposed at the output end 202 of the magazine 20 and includes a punching groove 41 and a nail feeding hole 42 which are in communication with each other. The nail feeding hole 42 extends along the radial direction Y and is in communication with the nail holding groove 21 and the sliding groove 22 of the magazine 20. One end of the punching groove 41 along the inserting direction X is formed with a hammer hole 411 for insertion of a hammer of the nail gun 99, and another end of the punching groove 41 along the inserting direction X is formed with a firing hole 412 through which the nail clips 10 is driven out of the muzzle 40.

Preferably, the nail gun is further provided with a loading cover 24 to cover the input end 201 of the magazine 20. The loading cover 24 includes a loading hole 241 for loading of nail clips 10 into the magazine 20.

Preferably, the nail gun is further provided with a connecting cover 43 which includes a pivoting end 431 to be pivoted to one end of the muzzle 40 where the hammer hole 411 is located, so that the connecting cover 43 is pivotable with respect to the muzzle 40 for facilitating the user to monitor the inside of the muzzle 40, and making it easier to remove the jammed nail clips. This embodiment further includes a connecting member 44 which is fixed at the end of the muzzle 40 where the hammer hole 411 is located and provided with a pivoting portion 441, so that the pivoting end 431 of the connecting cover 43 can be pivoted to the pivoting portion 441.

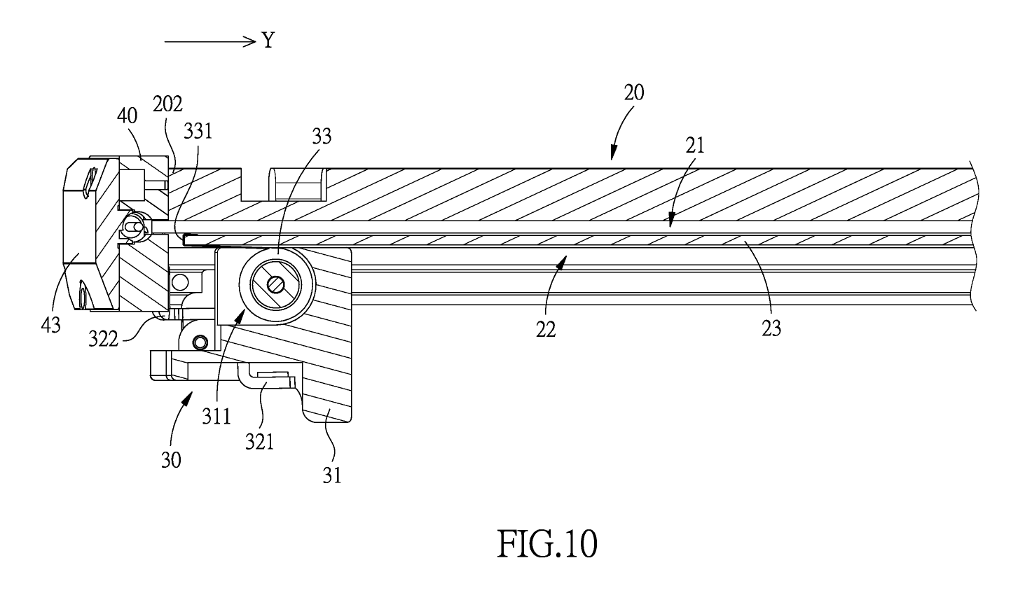

Referring to FIG. 10, when the nail clips 10 are not loaded in the magazine assembly of the present invention, the coil spring 33 has the positioning end 331 fixed to the output end 202 of the magazine 20 and is maintained in a compressed condition, and the coil spring 33 is revolvably disposed in the pushing member 31, the nail pushing assembly 30 is therefore maintained at the output end 202 of the magazine 20 by the spring force of the coil spring 33.

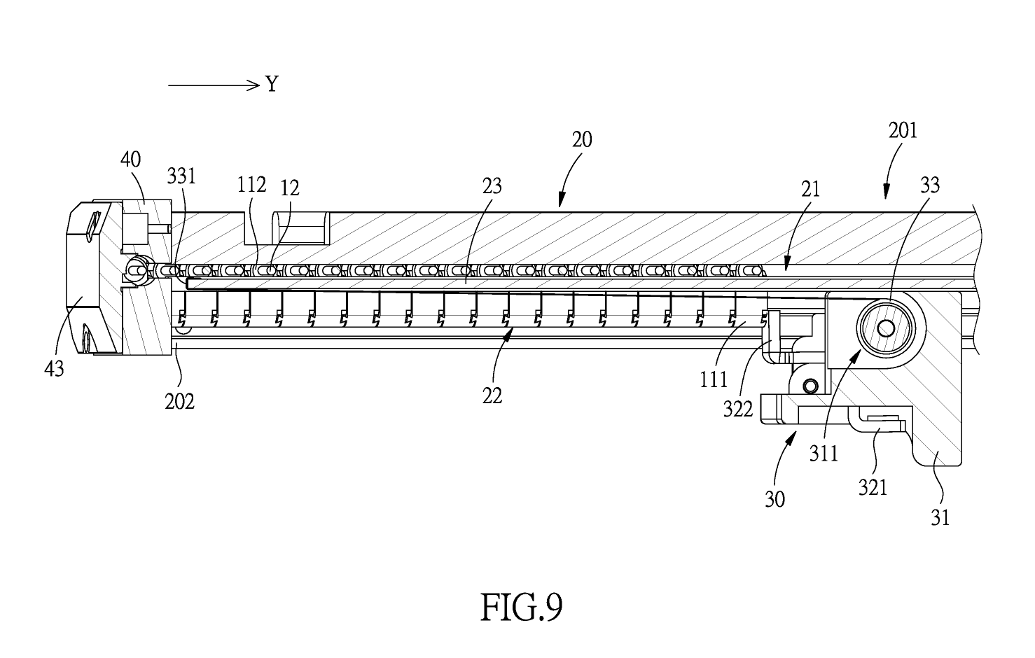

The use of the magazine assembly for accommodating of nail clips 10 in accordance with the preferred embodiment of the present invention is explained as follows. Firstly, as shown in FIG. 9, a user can push the nail pushing assembly 30 toward the input end 201 to provide a force counteracting the spring force of the coil spring 33, so as to keep the nail pushing assembly 30 at the input end 201 of the magazine 20.

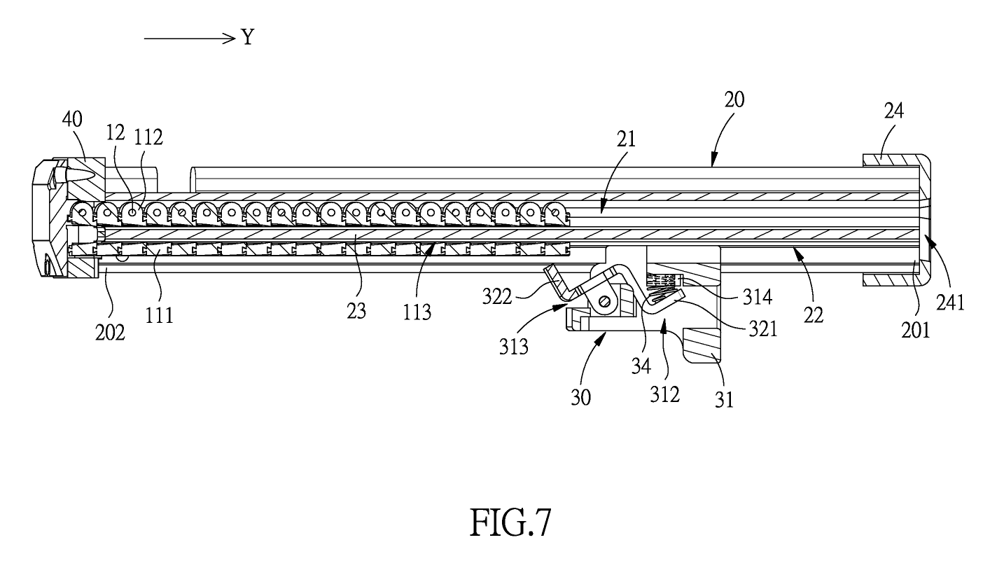

Then, as shown in FIG. 7, the user presses the pressing end 321 of the pushing piece 32 towards the magazine 20 to make the pushing end 322 pivot out of the sliding groove 22 of the magazine 20 (due to the pushing piece 32 is pivoted to the pushing member 31, and is therefore pivotable when pressed), so that the nail clips 10 can be loaded into the nail holding groove 21 via the input end 201 of the magazine 20.

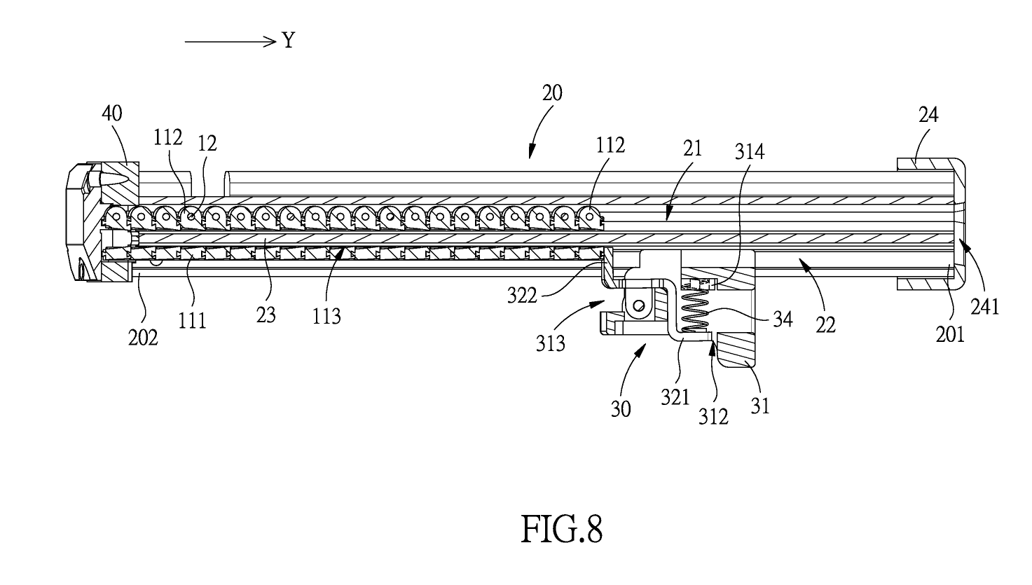

Referring then to FIG. 8, the user then releases the pressing end 321 of the pushing piece 32, the pushing piece 32 will be pushed reversely by the elastic member 34, so that the pushing end 322 will return to its original position and press against the clipping portion 111 of the nail clips 10, to prevent the nail clips 10 from disengaging out of the magazine 20 via the input end 201.

Referring further to FIG. 9, since the coil spring 33 has the positioning end 331 fixed to the output end 202 of the magazine 20 and is maintained in a compressed condition, the spring force of the coil spring 33 provides a pushing force pushing the pushing member 31 towards the output end 202. Besides, the pushing end 322 of the pushing piece 32 is pushed against the clipping portion 111 of the nail clips 10. Therefore, the nail pushing assembly 30 also provides a force for pushing the nail clips 10 toward the output end 202 of the magazine 20, so that the nail clips 10 close to the output end 202 can be pushed into the punching groove 41 via the nail feeding hole 42 of the muzzle 40.

When a nail clip 10 is being fired, the hammer of the nail gun 99 will move through the hammer hole 411 into the muzzle 40 to hit the nail 12 of the nail clip 10 located in the punching groove 41, making the engaging groove U of the nail clip 10 being hit disengage from the rib D of the clip base 11 of a neighboring nail clip 10, and thus the nail clip 10 hit by the hammer is driven out of the muzzle 40 via the firing hole 412.

With the inserting portions 112 of the nail clips 10 and the nails 12 received in the nail holding groove 21, the clipping portions 111 of the nail clips 10 received in the sliding groove 22, and the restricting protrusion 23 received in the retaining space 113 of the nail clips 10, the nail clips 10 can be held firmly in the magazine 20. Besides, the punching groove 41 and the nail feeding hole 42 of the muzzle 40 are in communication with the magazine 20 to allow the nail clips 10 to be pushed into the punching groove 41 where the nail clips can be fired. Hence, the magazine assembly is not only capable of accommodating but also firing the nail clips 10.

Preferably, the magazine 20 is an elongated structure for facilitating monitoring of the condition of the nail clips inside the magazine.

While we have shown and described various embodiments in accordance with the present invention, it is clear to those skilled in the art that further embodiments may be made without departing from the scope of the present invention.

What is claimed is:

1. A magazine assembly for accommodating of nail clips, being used in combination with a nail gun, each of the nail clips including a clip base and a nail, the clip base including a clipping portion and an inserting portion for insertion of the nail a direction in which the nail is inserted being defined as an inserting direction, a retaining space is formed between the clipping portion and the inserting portion, the magazine assembly comprising:
a magazine having an input end and an output end, a direction running from the input end to the output end being defined as a radial direction, the magazine including a nail holding groove and a sliding groove which are in communication with each other and extend in the radial direction, the nail holding groove being provided for accommodating of the inserting portions of the nail clips and the nail, and the sliding groove being provided for accommodating the clipping portions of the nail clips, a restricting protrusion being formed between the nail holding groove and the sliding groove and extending along the radial direction to fit in the retaining spaces of the nail clips, each of the clipping portions of the nail clips sitting over the restricting protrusion;
a nail pushing assembly including a pushing member, a pushing piece and a coil spring, the pushing member, which is disposed in the sliding groove and slidable along the radial direction, including a spring slot, a pressing slot and a pushing slot in communication with the pressing slot, wherein both the spring slot and the pushing slot are in communication with the nail holding groove and the output end, the pushing piece is pivoted to the pushing member and includes a pressing end and a pushing end, a pivot point of the pushing piece is located between the pressing end and the pushing end, the pressing end is located in the pressing slot, the pushing end is located in the pushing slot and inserted in the sliding groove to press against the nail clips, the coil spring is revolvably disposed in the spring slot, the coil spring has a positioning end fixed to the output end of the magazine, and has another end disposed in the spring slot, an elastic member is disposed between the mounting seat and the pressing end of the pushing piece; and
a muzzle disposed at the output end of the magazine, including a punching groove and a nail feeding hole which are in communication with each other, wherein the nail feeding hole extends along the radial direction and is in communication with the nail holding groove and the sliding groove of the magazine, the punching groove extends in the inserting direction, one end of the punching groove is formed with a hammer hole, and another end of the punching groove is formed with a firing hole.

2. The magazine assembly as claimed in claim 1, further comprising a loading cover to cover the input end of the magazine, wherein the loading cover includes a loading hole for loading of nail clips entering the magazine.

3. The magazine assembly as claimed in claim 1, further comprising a connecting cover which includes a pivoting end to be pivoted to one end of the muzzle where the hammer hole is located.

4. The magazine assembly as claimed in claim 1, wherein the pushing member is provided with a mounting seat located toward the pressing slot, and the elastic member is disposed between the mounting seat and the pressing end of the pushing piece.

5. The magazine assembly as claimed in claim 3, further comprising a connecting member which is fixed at one end of the muzzle where the hammer hole is located and provided with a pivoting portion, so that the pivoting end of the connecting cover is pivoted to the pivoting portion.

6. The magazine assembly as claimed in claim 1, wherein a retaining space has a close end and an open end, both of which are located in the inserting direction, the clip base includes a first lateral surface and a second lateral surface, the first lateral surface is provided with at least one rib extending in the inserting direction, the second lateral surface is provided with at least one engaging groove located corresponding to the rib, the rib has a stop end located adjacent to the open end of the retaining space, the engaging groove has an open end located at the close end of the retaining space, and a close end located between the close and open ends of the retaining space, so that two said nail clips are allowed to be fastened together in a stepped manner that the rib of one nail clip is engaged in the engaging groove of another nail clip, and the stop end of the one nail clip is stopped against the close end of the engaging groove of the another nail clip.
